(19) United States
(12) Patent Application Publication
(10) Pub. No.: US 2007/0086568 A1
(43) Pub. Date: Apr. 19, 2007

(54) DEVICE AND METHOD FOR SEPARATING BULK MATERIALS

(75) Inventors: Guenther Petzold III, Rellingen (DE); Hartmut Harbeck, Wedel (DE); Gerd Reischmann, Tornesch (DE)

Correspondence Address: LARSON AND LARSON, 11199 69TH STREET NORTH, LARGO, FL, 33773, US

(73) Assignee: COMMODAS DATEN-UNDSYSTEMTECHNIK NACH MASS GMBH, Wedel (DE)

(21) Appl. No.: 11/561,224

(22) Filed: Nov. 17, 2006

(30) Foreign Application Priority Data
Nov. 25, 2004 (WO) PCT/DE04/02615
Jan. 12, 2004 (DE) 102004001790.5

(51) Int. Cl. G01N 23/06

(52) U.S. Cl. 378/53; 209/589

(57) ABSTRACT

The invention relates to a device and method for separating bulk materials with the aid of a blow-out device provided with blow-out nozzles arranged on a fall section which is disposed downstream from a conveyor belt. The blow-out nozzles are controllable by computer-controlled evaluation means according to sensor results of radiation, which penetrates the flow of bulk material on the conveyor belt, and emitted from an x-ray source and captured in the sensor means. The x-ray radiation, which passes through the particles of the bulk material, is filtered into at least two spectra of differing energy ranges before the radiation is captured by local resolution with the aid of at least one sensor means integrated within an energy range.

### PRIOR APPLICATIONS

This application is a U.S. continuation-in-part basing priority on international application S.N. PCT/DE2004/002615, filed on Nov. 25, 2004, which in turn bases priority on German application S.N. 10 2004 001 790.5, filed on Jan. 12, 2004.

### BACKGROUND OF THE INVENTION

1. Field of the Invention

The invention relates to a device and a method for separating or sorting bulk materials according to the preamble of the main claim.

2. Description of the Prior Art

Devices for separating bulk materials require a large number of sensors, particularly optical and electromagnetic sensors, such as is described in the applicant's EP B1-1 253 981.

Besides such sensors it is also advantageous to use X-radiation for the non-destructive testing of material characteristics of all possible objects, which are not readily detectable on the surface.

In this connection, U.S. Pat. No. 6,122,343 only provides the information given in the introductory part of claim 1, and only the reference that superimposed arrays can be used as sensor means indicate the possible appearance of the filters on the detectors. No further details are given of data processing and, instead, merely an increased contrast image constitutes the sought result.

Particularly, through the observation of a high resolution image while observing two X-radiation energy levels and the mathematical evaluation of a resulting differential image, makes it possible to obtain information on the constituents of individual bulk material particles, but no teaching in this direction is provided by U.S. Pat. No. 6,122,343.

This is, for instance, of interest when separating ores, where the decision as to whether a particle is or is not discarded decisively depends on whether and possibly which material is present in a specific bulk material particle. The method can also be used in the separation of waste particles.

In known devices where X-ray sources were used, as a result of the not inconsiderable spatial dimensions of the X-ray sources and also the detectors, as well as the necessary screening or shielding, spatial demands have arisen making it impossible or only possible with considerable difficulty to bring about a place-precise evaluation, such as is required for the control of blow-out nozzles for blowing out smaller bulk material particles.

The problem of the invention is to provide a safe-saving arrangement with which it is not only reliably possible to detect small metal parts such as screws and nuts, but permitting the reliable separation thereof from the remaining bulk material flow through blow-out nozzles directly following the observation location.

### SUMMARY OF THE INVENTION

According to the invention, this problem is solved by the features of the main claim and, using two X-ray filters for different energy levels which are, in each case, brought in front of the sensors, different information concerning the bulk material particles can be obtained. Alternatively, the filters can directly follow the X-ray source, or use can be made of X-ray sources with different emitted energies.

The spatial arrangement of the filters can be fixed so that by moving the bulk material particles, it is possible to bring about a suitable filter-following reflection of the x-radiation, e.g., by crystals onto a detector line or row, in the case, of an association of two measured results recorded at different times for the bulk material particles advancing on the bulk material conveyor belt.

However, in another variant of the device, it is also possible to work with two sensors, which follow one another transversely to the conveyor belt extension and are, e.g., located below the same. Through suitable mathematical delay loops, it is then possible to associate the successively obtained image information with individual bulk material particles and, following mathematical evaluation, use the same for controlling the blow-out nozzles.

Through the upstream placing of filters, it is also possible to restrict the X-radiation to a specific energy level with respect to an X-ray source emitting in a broader spectrum prior to the same striking the bulk material particle. No further filter is then required between the bulk material particles and a downstream sensor.

It is also proposed that the device be equipped with a shield which is, obviously, provided around the X-ray source and the irradiation location of the bulk material particles, and the actual sensors in a X-ray-tight manner, but which also extends on the bulk material conveyor belt surface up to a filling device filling the conveyor belt via a sloping chute. This ensures that operating personnel can remain around the sorting and separating device. Covers must be secured in such a way that on removal the device cannot be operated.

The inventive method for separating bulk materials with the aid of a blow-out device operates with blow-out nozzles located on a fall section downstream of a conveyor belt, the blow-out nozzles being controlled by a computer-assisted evaluating means as a function of the sensor results of radiation penetrating the bulk material flow on the conveyor belt, which is emitted by an X-ray source and is captured in sensor means.

Filtering of the X-radiation, which has traversed bulk material particles, takes place in at least two different spectra for the place-resolved capturing of the X-radiation, which has traversed the bulk material particles integrated in at least one line sensor over a predetermined energy range. This can take place when using a sensor means (a long line formed from numerous individual detectors) by passing through different filters and successive capturing of the transmitted radiation or, preferably, by two sensor lines with, in each case, a different filter, the filters permitting the passage of different spectra, which on the one hand tend to have a soft and on the other a hard character.

A Z-classification and standardization of image areas takes place for determining the atomic density class on the basis of the sensor signals of the X-ray photons of different energy spectra captured in the at least two sensor lines.

Finally, the objective can advantageously be achieved by a segmentation of the characteristic class formation for controlling the blow-out nozzles on the basis of both the detected average transmission of the bulk material particles in the different X-ray energy spectra captured by the at least two sensor lines, and also the density information obtained by Z-standardization.

### BRIEF DESCRIPTION OF THE DRAWINGS

The detailed description of the invention, contained herein below, may be better understood when accompanied by a brief description of the drawings, wherein:

FIG. 1 illustrates a cut-away side view of FIG. 2 of the device for separating bulk materials of the present invention;

FIG. 2 illustrates a perspective view of the device of the present invention, shown with removed radiation protection above the conveyor belt;

FIG. 3 illustrates a diagrammatic view of the method of the X-ray sensor means structure of the present invention;

FIG. 3A illustrates a diagrammatic view of the two-channel sensor means of FIG. 3 of the present invention;

FIG. 4 illustrates a diagrammatic view of the method of the X-ray signal processing structure of the present invention.

### DETAILED DESCRIPTION OF THE PREFERRED EMBODIMENT

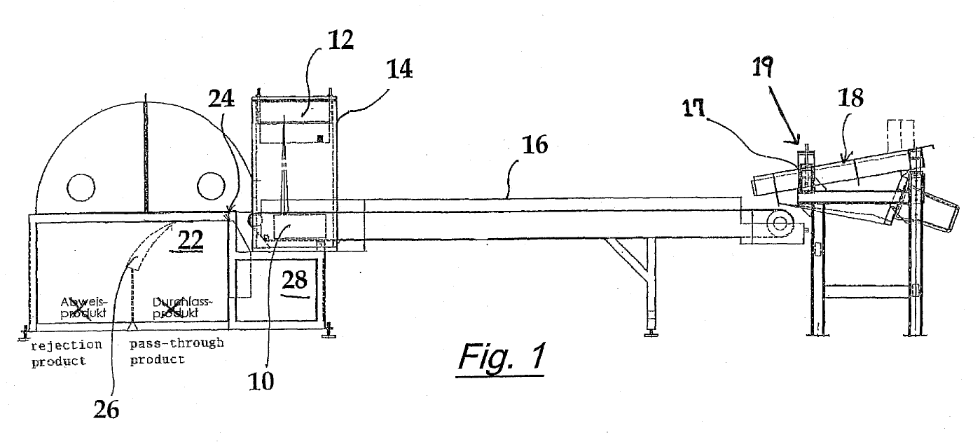

FIG. 1 shows a flat detector 10 positioned below a conveyor belt 20 and an X-ray source 12 positioned above a conveyor belt 20, which by means of downstream blow-out nozzles 24 located in two different product chambers, it is possible to separate a rejection product from a pass-through product in the bulk material flow. A wedge-like separating element 26 between the two product flows can have its slope adjusted so that it is easily possible to adapt to products of different heaviness with different flight characteristics without the blow-out air pressure having to be subsequently adjusted.

FIG. 1 also shows how, above the conveyor belt 20, there is a cover 16 for preventing X-radiation reflected against the product delivery direction passing out to the separating device. On the filling side there is a seal 17 of the conveyor belt box 19 through a sloping material delivery chute 18 on conveyor belt 20, so that radiation cannot pass out counter to the conveying direction parallel to the conveyor belt.

The device for separating bulk materials with the aid of a blow-out device with blow-out nozzles 24 located on a fall section downstream of a conveyor belt 20 consequently largely comprises computer-assisted evaluating means which can be controlled as a function of sensor results of two captured X-ray transmitted light images penetrating the bulk material flow on the conveyor belt 20, emitted by an X-ray source 12 and captured in sensor means 10. There are also two filter devices (not shown) for passing on X-radiation in relation to mutually different energies placed upstream of the at least one sensor means 10, said sensor means being line sensors with a plurality of individual pixels positioned transversely to the conveyor belt 20. In particular, there can be one sensor line for each filter.

A sensor line (not shown) corresponding to the conveyor belt width is formed by lined u4p photodiode arrays, whose active surface is covered with a fluorescent paper. The filters are preferably metal foils through which X-radiation of different energy levels is transmitted. However, the filters can also be formed by crystals, which reflect X-radiation to mutually differing energy levels, particularly X-radiation in different energy ranges in different solid angles.

There can also be more than two filters for the use of more than two energy levels. Advantageously, the filters are located below the conveyor belt 20 upstream of the sensor means 10, and above the conveyor belt 20 is located an X-ray tube 12 producing a brems spectrum.

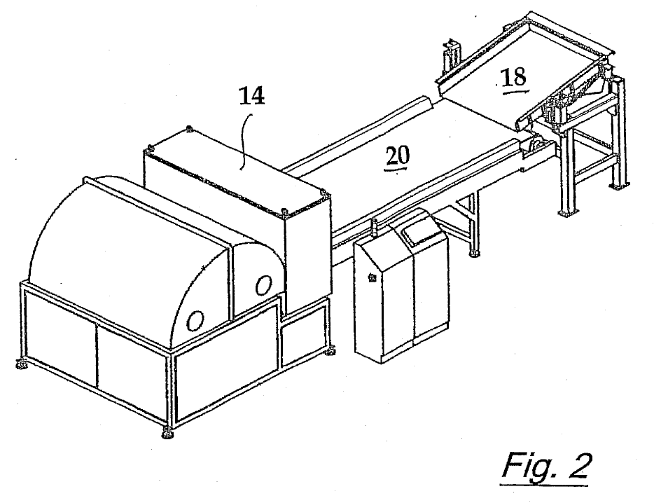

The device is equipped with a shielding box 14, above the conveyor belt 20, and surrounds the conveyor belt and the blow-out section 22, whereby a cover 16 covers the conveyor belt 20 in a section upstream of the X-ray source 12, and at the beginning of the belt there is a sloping chute 18 covering the entrance cross-section (shown respectively in FIG. 2). In the device shown inter alias, glass ceramic is separated from bottle glass. However, the different glass types, as used in display screen tubes which in part have much higher melting points than “normal glass” and constitute a material difficult to separate in the recycling of broken glass, can now for the first time be separated using the device according to the present invention.

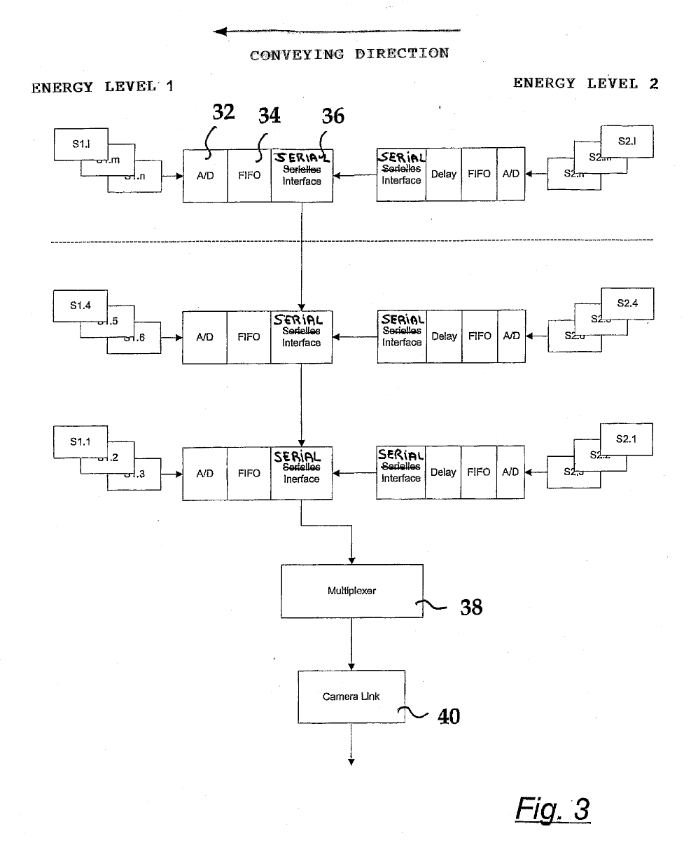

For the better understanding of the separating procedure, a technical description will now be given of X-ray signal processing by means of two X-ray transmission spectra and segmentation into characteristic classes. A suitable coverage is to be ensured within the framework of X-ray sensor means (see FIG. 3), and this is achieved by a filter technique having spectral resolution.

Through a suitable filtering of the X-radiation upstream of the particular sensor of the two-channel system, there is firstly a spectral selectivity. The arrangement of the sensor lines then permits an independent filtering so that the optimum selectivity for a given separating function can be achieved.

Generally, a higher energy spectrum and a lower energy spectrum are covered. For the higher energy spectrum, a high pass filter is used which greatly attenuates the lower frequencies with lower energy content. The high frequencies are transmitted with limited attenuation. For this purpose, it is possible to use a metal foil of a metal with a higher density class, such as a 0.45 mm thick copper foil. For the lower energy spectrum, the filter is used upstream of the given sensor as an absorption filter which suppresses a specific higher energy wave range. It is designed in such a way that the absorption is in close proximity to the higher density elements. For this purpose, it is possible to use a metal foil of a lower density class metal, such as a 0.45 mm thick aluminum foil.

Each of the two sensor lines S1.i and S2.i (e.g., from n times 1 to n times 64 for all the lined up arrays over the conveying width) comprises a plurality of photodiode arrays equipped with a scintillator for converting X-radiation into visible light.

A typical array has 64 pixels (in one row) with either 0.4 or 0.8 mm pixel raster. As diagrammatically shown in FIG. 3, by means of analog amplifiers and analog/digital converters 32, the intensity is digitized with 14 bit dynamics and read out in line-synchronous manner using FIFO (First In/First Out) memories 34 and a serial interface 36. The line first cut from the sorting product, as a result of the material conveying direction, is delayed until the data are quasi-simultaneously available with those of the subsequently cut line (with the other energy spectrum).

The thus time-correlated data are converted by multiplexer 38 into a byte-serial data stream and transmitted via the standard interface Camera Link 40 over a distance of several meters to the evaluation electronics.

By lining up electronic modules, which in each case cover a 300 mm conveying width, it is possible to build up in two-channel form maximum conveying widths of 1800 mm. For this purpose, on each module the necessary operating voltages are generated anew and the clock signals are prepared anew.

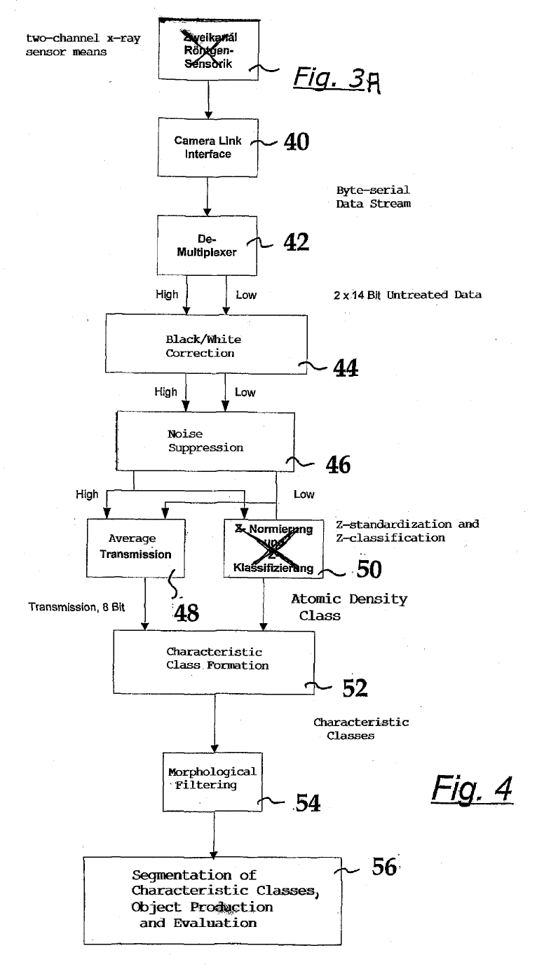

The X-ray signal processing takes place on the data stream transmitted via Camera Link 40 (shown diagrammatically in FIG. 4) and undergoes separation into two sensor channels, again using de-multiplexer 42.

For each channel, separately a black/white correction is carried out in an electronic unit 44. On measuring this correction stage, for each pixel determination takes place of the black value in the absence of radiation and the white value for 100% radiation, and an adjustment or compensation table is used. In normal operation the untreated data are corrected with the aid of said table. For suppressing signal noise 46, separately and for each channel by the buffer storage of a number of following lines, temporarily an image is built up and is smoothed by a mean value filter whose size in rows and columns can be adjusted. This significantly reduces noise.

Z-transformation 50 produces from the intensities of two channels of different spectral imaging n classes of average atomic density (abbreviated to Z), whose association is largely independent of the X-ray transmission and, therefore, the material thickness.

A standardization of the values to an average atomic density of one or more selected representative materials makes it possible to differently classify image areas on either side of the standard curve. A calibration, in which over the captured spectrum the context is produced in non-linear manner, enables the “fading out” of equipment effects.

The atomic density class generated during the standardization to a specific Z (atomic number of an element or, more generally, average atomic density of the material) forms the typical density of the participating materials. In parallel to this, a further channel is calculated providing the resulting average transmission over the entire spectrum 48.

By computer-assisted combination of the atomic density class with a transmission interval (Tmin-, Tmax) to the pixels, can be allocated a characteristic class 52 which, following morphological filter 54, can be used for material differentiation 56.

Here again in temporary manner, an image of a few lines height is built up in order to suppress interfering information with a bi-dimensional filter. It is, e.g., possible for undesired misinformation to be suppressed at the edge of particles by cut pixels.

The data stream of characteristic classes 52 is treated as image material. The “machine idling” characteristic class describes the state when the X-ray source is switched on without sorting material in the measurement section. All characteristic pixels diverging from machine idling are processed as foreground and combined by segmentation to line segments, and finally to surfaces. The characteristic distributions over these surfaces are described by object data sets. In addition, said data sets also contain information regarding the position, shape and size of the linked characteristic surfaces.

In the evaluation quantity relations of the characteristic pixels, as well as the shape and size per object, are compared with learned parameters per material. On this basis the object is associated with a specific material class.

Having thus described the present invention in the detailed description of the preferred embodiment, what is desired to be obtained in Letters Patent is:

1. A device for separating bulk materials aided by a blow-out device having blow-out nozzles located on a fall section downstream of a conveyor belt and an X-ray source, computer-controlled evaluating means and at least one sensor means, the blow-out nozzles controllable by the computer-controlled evaluating means as a function of sensor signals resulting from radiation penetrating a flow of said bulk material on said conveyor belt, said radiation being emitted by the X-ray source and captured in the at least one sensor means, the device for separating bulk material comprising at least two filter devices for permitting a passage of X-radiation in relation to mutually different energy spectra positioned upstream of the at least one sensor means and sensor lines with a plurality of individual pixels positioned transversely to the conveyor belt as sensor means, a sensor line being provided for each of the at least two filters.

2. The device according to claim 1, wherein a sensor line corresponding to a width of said conveyor belt is formed by linearly disposed photodiode arrays, whose active surface is covered with a fluorescent paper.

3. The device according to claim 1, wherein the at least two filters are metal foils through which the X-radiation of mutually different energy levels is transmitted.

4. The device according to claim 1, wherein the at least two filters are positioned below the conveyor belt and upstream of the sensors, and an X-ray tube producing a brems spectrum is positioned above the conveyor belt.

5. The device according to claim 1, wherein said device comprising a shielding box positioned above said conveyor belt for surrounding said conveyor belt and a blow-out section, while a covering covers the conveyor belt in a section upstream of the X-ray source, and at a start of said conveyor belt, a sloping chute covers an entrance cross-section.

6. The device according to claim 1, wherein the at least two filters including a plurality of filters for using with a plurality of energy levels.

7. A method for separating bulk material aided by a blow-out device having blow-out nozzles located on a fall section downstream of a conveyor belt, the blow-out nozzles controllable by a computer-controlled evaluating means as a function of sensor results of radiation penetrating a flow of said bulk material on the conveyor belt, and which is emitted by an X-ray source and captured by a sensor means, the steps of the method comprising:
filtering X-radiation, which has traversed particles of said bulk material into at least two different spectra filtered by a use of metal foils for a location-resolved capturing of said X-radiation, which has traversed said particles of said bulk material that has integrated in at least one sensor line for a filter, over a predetermined energy range.

8. The method according to claim 7, wherein there is a Z-classification and standardization of image areas for determining an atomic density class on a basis of the sensor signals of x-ray photons of different energy spectra captured in at least two sensor lines.

9. The method according to claim 8, wherein there is a segmentation of a characteristic class formation for controlling the blow-out nozzle on a basis of both a detected average transmission of said particles of said bulk material in different X-ray energy spectra captured by the at least two sensor lines, and a density information obtained by Z-standardization.
